(19) United States
(12) Patent Application Publication
(10) Pub. No.: US 2002/0087312 A1
(43) Pub. Date: Jul. 4, 2002

(54) Computer-implemented conversation buffering method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/863,938

(22) Filed: May 23, 2001

Related U.S. Application Data
(60) Provisional application No. 60/258,911, filed on Dec. 29, 2000.

(51) Int. Cl. G10L 15/04; G10L 15/00

(52) U.S. Cl. 704/251

(57) ABSTRACT

A computer-implemented method and system for processing spoken requests from a user. A spoken first request from the user is received, and keywords in the first request are recognized for use as first searching criteria. The first request of the user is satisfied through use of the first searching criteria. A second spoken request from the user is received, and keywords in the second request are recognized for use as second searching criteria. Upon determining that additional data is needed to complete the second searching criteria before satisfying the second request, at least a portion of the recognized keywords of the first request is used to provide the additional data for completing the second searching criteria. Thereupon, the second request of the user is satisfied through use of the completed second searching criteria.

### RELATED APPLICATION

This application claims priority to U.S. Provisional Application Serial No. 60/258,911 entitled “Voice Portal Management System and Method” filed Dec. 29, 2000. By this reference, the full disclosure, including the drawings, of U.S. Provisional Application Serial No. 60/258,911 is incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in telephony computer service applications because they offer a more natural way for information to be acquired from people. For example, speech recognition systems are used in telephony applications wherein a user requests through a telephonic device that a service be performed. The user may be requesting weather information to plan a trip to Chicago. Accordingly, the user may ask what is the temperature expected to be in Chicago on Monday.

The user may next ask that a trip be planned in order to reserve a hotel room, air flight ticket, or other travel-related items. Previous telephony applications often ignore valuable information that may have been previously mentioned during the same phone session. For example, previous telephony applications would not effectively utilize the information that the user provided in requesting the weather information for the other service request. This results in additional information prompts from the telephony application wherein the user must repeat information.

The present invention overcomes this disadvantage as well as others. In accordance with the teachings of the present invention, a computer-implemented method and system are provided for processing spoken requests from a user. A spoken first request from the user is received, and keywords in the first request are recognized for use as first searching criteria. The first request of the user is satisfied through use of the first searching criteria. A second spoken request from the user is received, and keywords in the second request are recognized for use as second searching criteria. Upon determining that additional data is needed to complete the second searching criteria before satisfying the second request, at least a portion of the recognized keywords of the first request is used to provide the additional data for completing the second searching criteria. Thereupon, the second request of the user is satisfied through use of the completed second searching criteria.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used to manage a conversation with a user.

### DETAILED DESCRIPTION OF THE PREFERRED EMBODIMENT

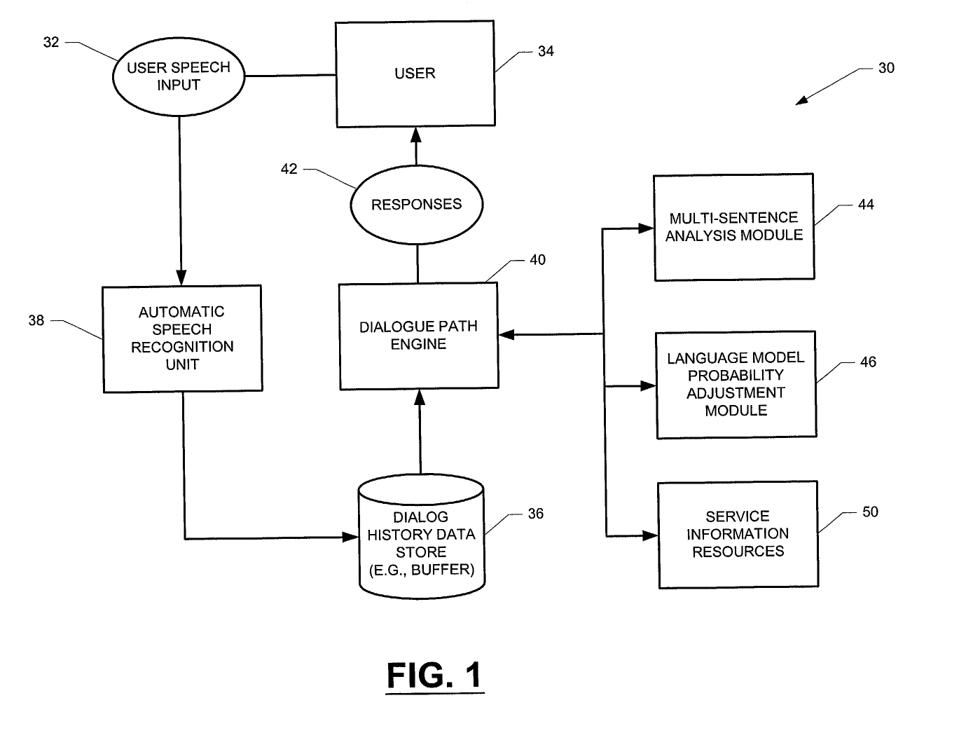

FIG. 1 depicts a computer-implemented dialogue management system 30. The dialogue management system 30 receives speech input 32 during a session with a user 34. The user 34 may mention several requests during the session. The dialogue management system 30 maintains a record of the user's requests in the dialogue history buffer 36 as a reference point for subsequent user requests and responses. By accessing the dialogue history buffer 36, the dialogue management system 30 directs the conversation with the user by using important keywords and concepts that have been retained across requests. This allows the user to speak naturally without having to repeat information. The user can abbreviate requests as she would in a conversation with another person.

The user speech input 32 is recognized by an automatic speech recognition unit 38. The automatic speech recognition unit 38 may use such known recognition techniques as the Hidden Markov Model technique. Such models include probabilities for transitions from one sound (e.g., a phoneme) to another sound appearing in the user speech input 32. The Hidden Markov Model (HMM) technique is described generally in such references as “Robustness In Automatic Speech Recognition”, Jean Claude Junqua et al., Kluwer Academic Publishers, Norwell, Mass., 1996, pages 90-102.

The automatic speech recognition unit 38 relays multiple HMM keyword hypotheses from the scanning results of the user speech input 32 to the dialogue history buffer, where it is stored as context for subsequent requests. The dialogue history buffer 36 also stores the history of the responses 42 that are generated by the system 30. The dialogue history buffer 36 has information cache buffering technology for retaining sentences used in the contextualization of subsequent requests.

A dialogue path engine 40 generates responses 42 to the user 34 based in part upon the previous user requests and the previous system responses. The dialogue path engine 40 uses a multi-sentence analysis module 44 to keep track of the logical progression from one request to the next. The multi-sentence analysis module 44 uses the keyword hypotheses from the dialogue history buffer 36 to make predictions about the current context for the user request. A dialogue path engine is described in applicant's United States application entitled “Computer-Implemented Intelligent Dialogue Control Method and System” (identified by applicant's identifier 225133-600-021 and filed on May 23, 2001) which is hereby incorporated by reference (including any and all drawings).

The dialogue path engine 40 also uses a language model probability adjustment module 46 to adjust the probabilities of the language models based on the past request histories and recent requests in the dialogue history buffer 36. For example, if the previous requests stored in the dialogue history buffer 36 concern weather, then the language model probability adjustment module 46 adjusts probabilities of weather-related language models so that the automatic speech recognition unit 38 may use the adjusted language models to process subsequent requests from the user. A language model probability adjustment module is described in applicant's United States application entitled “Computer-Implemented Expectation-Based Probability Method and System” (identified by applicant's identifier 225133-600-011 and filed on May 23, 2001) which is hereby incorporated by reference (including any and all drawings).

As a further example, the user may request, “What is the hottest city in the U.S.” The automatic speech recognition unit 38 relays the recognized speech input to the dialogue history buffer 36 where it is stored as context for the dialogue with the user. Keywords in the request are categorized according to their relevance to weather condition, time, location, or duration. The system 30 processes the recognized request by retrieving from one or more service information resources 50 (such as a weather Internet database) the correct information. The system then uses the buffered data to determine the context for the next request, which in this example pertains to the coldest city. The previously supplied phrase “In the U.S.” is the implied context for the second request, so the user is not required to repeat this information. The language model probability adjustment module 46 is able to predict from the first request that the next relevant category may be the “coldest” category because the probabilities of cold-related words in the weather models have had their recognition probabilities increased. Without the dialogue history buffer 36, the system would be required to query about the location in the second request.

The preferred embodiment described within this document is presented only to demonstrate an example of the invention. Additional and/or alternative embodiments of the invention should be apparent to one of ordinary skill in the art upon reading the aforementioned disclosure.

It is claimed:

1. A computer-implemented method for processing spoken requests from a user, comprising the steps of:
receiving speech input from the user that contains a first request;
recognizing keywords in the first request to use as first searching criteria;
satisfying the first request of the user through use of the first searching criteria;
receiving speech input from the user that contains a second request;
recognizing keywords in the second request to use as second searching criteria;
determining that additional data is needed to complete the second searching criteria for satisfying the second request;
using at least a portion of the recognized keywords of the first request to provide the additional data for completing the second searching criteria; and
satisfying the second request of the user through use of the completed second searching criteria.
